(19) United States
(12) Patent Application Publication
(10) Pub. No.: US 2024/0197065 A1
(43) Pub. Date: Jun. 20, 2024

(54) Cosmetic product applicator

(71) Applicant: TEXEN, Brion (FR)

(72) Inventors: Mohamed Mounder KOUICEM, BOURG-EN-BRESSE (FR); Denis PACCAUD, LYON (FR)

(21) Appl. No.: 18/544,990

(22) Filed: Dec. 19, 2023

(30) Foreign Application Priority Data
Dec. 19, 2022 (FR) 2213878
Feb. 6, 2023 (FR) 2301115

(51) Int. Cl. A46B 9/02; A45D 34/04; A46B 3/00; A46B 9/00; A46D 1/00

(52) U.S. Cl. CPC A46B 9/021; A45D 34/042; A46B 3/005; A46B 9/005; A46B 9/025; A46B 9/026; A46B 9/028; A46D 1/0207; A46D 1/0238; A46B 2200/1046; B29C 45/14385

(57) ABSTRACT

An applicator for a cosmetic product on the skin or bristles having an application member, made of a thermoplastic elastomer material, the application member including a core extending along a longitudinal axis, and application elements formed at the surface of the application member, each of the application elements having a top with a width greater than 35 μm and smaller than 450 μm.

### CROSS REFERENCE TO RELATED APPLICATIONS

This application is related to and claims the benefit of French Patent Application Number 2213878 filed on Dec. 19, 2022 and French Patent Application Number 2301115 on Feb. 6, 2023, the entire contents of both of said applications are herein incorporated by reference.

### TECHNICAL FIELD

The present disclosure relates to the field of make-up cosmetic product and skin care product applicators. The present disclosure relates more particularly to flocked-texture applicators for applying in particular lip gloss or lip oil and a concealer, and possibly mascara. The disclosure also relates to a method for manufacturing such an applicator.

### BACKGROUND

The applicators in particular for lip gloss or lip oil generally have a flock formed of bristles bonded to a support. Such a flock requires several manufacturing steps to assemble parts made of different materials. As a result, the applicator is difficult to recycle.

The patent application US2019/0343262 describes a cosmetic applicator including a hard plastic frame and silicone bristles radially arranged and covering the external periphery of the frame. Due to the fragility of the bristles, this applicator cannot be manufactured by conventional injection molding, but by vacuum injection molding.

The patent application US2008/0083421 describes a mascara applicator likely to be molded in one piece by injection including a rod, a hub formed at the end of the rod, and members provided with bristles extending radially from the hub. The members are intended to be kept folded along the rod, the bristles on the members extending substantially radially from the axis of the rod.

The patent application US2021/0323205 describes a method for manufacturing a cosmetic applicator comprising a step of injection molding a thermoplastic material. This molding step involves a mold whose inner surface has micro-engraved cavities intended to form a flock.

The formation of flock or bristles by molding leads to numerous defects during molding and demolding in particular due to the very fine shapes of the flock or the bristles.

The patent application FR 3 091 983 also describes a method for manufacturing a cosmetic product applicator comprising steps of mixing the thermoplastic material with an inert gas and injecting the mixture into a mold, to obtain a microporous surface structure.

It is therefore desirable to propose a cosmetic or skin care product applicator with a flocked texture that is effective, both in supporting the product, and in transferring it to the skin or to the eyelashes or eyebrows. It can also be desirable for the applicator to be easily manufactured, by injection molding of a thermoplastic elastomer material, and with the lowest possible rate of manufacturing defects.

### BRIEF SUMMARY

Embodiments relate to an applicator for a cosmetic product on the skin or bristles, comprising an application member made of a thermoplastic elastomer material, the application member comprising: a core extending along a longitudinal axis, and application elements formed on the surface of the application member, each of the application elements having a top with a width greater than 35 μm and smaller than 450 μm.

Such an applicator has the advantage of being able to be produced only by molding, while having a flocked texture, which can be easily demolded due to the enlarged, substantially flat tops of the application elements.

According to one embodiment, the top of the application elements has a length larger than their width.

In this way, it is possible to obtain a surface having both more and less hydrophobic properties according to the relevant direction. The hydrophobic character can be adapted depending on the cosmetic product to be applied, simply by adjusting the dimensions of the tops and the distances between the tops of the application elements.

According to one embodiment, the top of the application elements have a rectangular shape, or the application elements have the shape of parallel ribs.

This arrangement allows combining hydrophilic and hydrophobic characters, capable of both sufficiently retaining the cosmetic product, and easily transferring the latter to the skin or the eyelashes.

According to one embodiment, the application elements have a width comprised between 40 and 400 μm.

These dimensions are particularly adapted to the function of applying a cosmetic product.

According to one embodiment, the application elements have a height comprised between 350 and 600 μm.

Such a depth allows retaining a sufficient quantity of cosmetic product, without disturbing the hydrophobic character of the relief formed by the application elements. Furthermore, the application elements can deform during the application and release the product accumulated between them.

According to one embodiment, the application elements, are spaced apart from each other by a distance comprised between one and two and a half times the width of the top of the application elements.

Such a distance allows retaining a sufficient quantity of the cosmetic product, while offering the required hydrophobic character.

According to one embodiment, the core has a circular or helical-shaped groove.

This groove allows retaining an additional quantity of cosmetic product.

According to one embodiment, the core comprises two drop-shaped portions arranged along the longitudinal axis, the two portions delimiting between them an annular groove.

This shape has a good ergonomic while allowing retaining an additional quantity of cosmetic product.

According to one embodiment, the application member comprises a plurality of parts engaged on a rod of the applicator, the application elements being formed on all or part of the surface of the parts.

According to one embodiment, each of the parts comprises two fin-shaped portions connected to each other by a portion forming a hub in which the rod of the applicator is engaged, the fin-shaped portions forming fins about the rod of the applicator.

According to one embodiment, each of the parts has the shape of a star with a hub in which the rod of the applicator is engaged and radial elements extending radially about the hub.

Embodiments may also relate to a method for manufacturing a cosmetic applicator as previously defined, the method comprising a step of molding a thermoplastic elastomer material, using a mold complementary in shape to that of the applicator, having a plurality of cavities complementary in shape to those of the application elements of the applicator.

The particular shape of the applicator with application elements having a top with a relatively large width, enables it to be manufactured in a single molding step, with a low risk of breakage of the application elements during demolding. As a result, the number of manufacturing defects is reduced and the cleaning operation of the mold which may be required to be performed between two molding operations is simplified.

According to one embodiment, the method comprises a step of manufacturing a mold, the cavities being formed using a femtosecond laser.

The properties of the surfaces formed by such a laser allow both obtaining an easy demolding with a low risk of breakage and molding surfaces having a good affinity for the cosmetic products to be applied.

Embodiments may also relate to a mold for manufacturing a cosmetic product applicator as previously defined, the mold comprising a molding surface having a plurality of cavities complementary in shape to those of the application elements of the applicator.

### BRIEF DESCRIPTION OF THE FIGURES

The present disclosure will be well understood using the following description of embodiments with reference to the appended figures, in which identical reference signs correspond to structurally and/or functionally identical or similar elements.

FIG. 1 is a schematic longitudinal sectional view of a cosmetic applicator, according to one embodiment,

FIG. 2 is a schematic cross-sectional view, of a relief formed at the surface of the cosmetic applicator, according to one embodiment,

FIG. 3 is a schematic front view of the relief formed at the surface of the cosmetic applicator, according to one embodiment,

FIG. 4 is a schematic longitudinal sectional view of a mold for manufacturing a cosmetic applicator, according to one embodiment,

FIG. 5 is a schematic front view of the relief formed at the surface of the cosmetic applicator, according to another embodiment,

FIG. 6 is a schematic front view of the relief formed at the surface of the cosmetic applicator, according to another embodiment,

FIG. 7 is a schematic sectional view of a water drop deposited at the surface of the applicator,

FIG. 8 is a schematic longitudinal sectional view of a cosmetic applicator, according to another embodiment,

FIG. 9 is a schematic longitudinal sectional view of a cosmetic applicator, according to another embodiment,

FIG. 10 is a schematic perspective view of another cosmetic applicator, according to another embodiment,

FIG. 11 represents schematic perspective views of parts forming the cosmetic applicator of FIG. 10,

FIG. 12 is a schematic perspective view of a part of a cosmetic applicator, according to another embodiment,

FIG. 13 is a schematic perspective view of a cosmetic applicator formed by the part of FIG. 12, according to one embodiment,

FIG. 14 is a schematic perspective view of another cosmetic applicator, according to another embodiment,

FIG. 15 is a schematic front view of a part forming the cosmetic applicator of FIG. 14.

### DETAILED DESCRIPTION

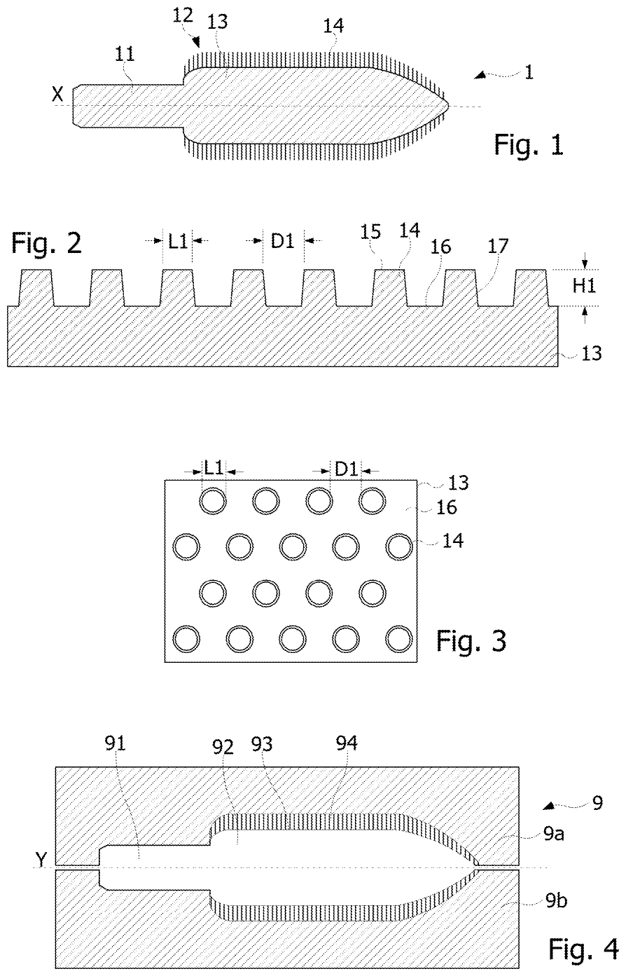

FIG. 1 represents a cosmetic applicator 1 comprising a rod 11 having a longitudinal axis X, secured to an applicator member 12 comprising a core 13 carrying a plurality of application elements 14 distributed over at least one portion of the surface of the core 13.

In the example of FIG. 1, the core 13 has an elongated shape according to its longitudinal axis X, and a substantially conical distal end.

According to an embodiment illustrated by FIGS. 2 and 3, each application element 14 of at least one portion of the application elements 14 has a top 15 with a width L1, which can extend in a surface parallel to a portion of the surface 16 of the core 13 where the application element is located. The application elements 14 extend over a height H1 above the surface 16 of the portion of the core 13 where they are located. The tops 15 of the application elements 14 of the portion of the application elements 14 are spaced apart from each other by a distance D1. The tops of the application elements 14 are substantially flat to within 10% of the height H1.

The shape of the application elements 14 with a wide top, has the advantage of being easy to demold, in particular by reducing the risk of breakage of the ends of the application elements in the mold reliefs.

According to one embodiment, the distance D1 between the application elements 14 is comprised between one and three times the width L1. According to one embodiment, the width L1 of the application elements 14 is comprised between 80 and 160 μm, and preferably comprised between 90 and 150 μm. The distance D1 between the application elements 14 is comprised between 80 and 160 μm, and preferably comprised between 90 and 150 μm. The maximum height H1 of the application elements 14 is comprised between 350 and 600 μm. In the direction of the ends of the core 13 along the longitudinal axis X, the application elements 14 may have a decreased height H1, as shown in FIG. 1.

In the example of FIG. 3, the application elements 14 have a circular-shaped top with a diameter L1.

According to one embodiment, the applicator 1 is manufactured in one piece using a mold, by injection of a thermoplastic elastomer (TPE) material. FIG. 4 represents an example of such a mold 9. In the example of FIG. 4, the mold 9 is for example formed of two mold halves 9a, 9b delimiting between them a volume corresponding to that of the applicator 1. This volume comprises a portion 91 allowing molding the rod 11 and a portion 92 allowing molding the core 13 of the applicator 1 and the application elements 14. To mold the application elements 14, the mold halves 9a, 9b have a plurality of cavities 94 formed in the walls 93 delimiting the core 13. The molding surfaces of the mold halves 9a, 9b may have identical shapes.

According to one embodiment, the cavities 94 are made of the material forming the mold halves 9a, 9b using a femtosecond laser. Such a laser allows making a relief in a mold surface with sufficient accuracy to form the application elements 14, the lateral faces 17 of the application elements 14 being substantially perpendicular (to within 15°) to the surface 16 of the core 13. This technique for forming the cavities 94 also has the advantage of forming a relief and surfaces having a good affinity for the cosmetic products to be applied.

It should be noted that the enlarged and flat or substantially flat shape of the tops 15 of the application elements 14 reduces the risk of breakage during demolding, relative to sharp application elements. The cleaning operation of the mold between two molding operations is therefore simplified.

It should also be noted that the cavities 94 are directed perpendicular to the interface plane between the two mold halves and therefore can be easily produced by directing the laser perpendicular to this plane.

The applicator 1 can be made of a thermoplastic elastomer TPE such as SEBS (polystyrene-b-poly(ethylene-butylene)-b-polystyrene) and/or of a thermoplastic material having a hardness of around 30 shore A (to within + or −10%). The SEBS has the advantage of being pleasant to the touch and therefore suitable for contact with the skin.

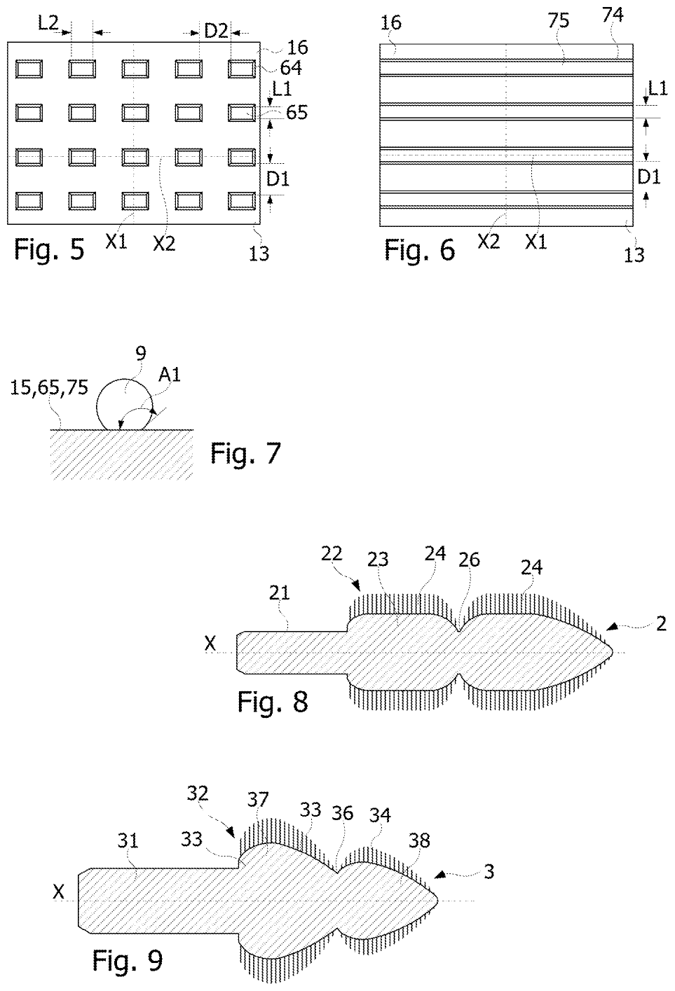

FIG. 5 represents a relief formed by application elements 64 produced on the surface of the core 13, according to another embodiment. Each of the application elements 64 has a rectangular-shaped top 65 with a width L1 and a length L2. The tops 15 of the application elements 64 are spaced apart from each other in the direction X1 of the width L1 by a distance D1 and in a direction X2 of the length L2 by a distance D2. The application elements 64 may also have the height H1 above the surface 16 of the core 13. According to embodiments, the width L1 and the length L2 are respectively comprised between 150 and 250 μm and between 350 and 450 μm, and are preferably respectively equal to 200 and 400 μm (to within + or − 10%). The distances D1 and D2 are comprised between 350 and 450 μm, and are preferably equal to 400 μm (to within + or −10%).

FIG. 6 represents a relief formed by application elements 74 produced on the surface of the core 13, according to another embodiment. Each of the application elements 74 has a rib-shaped top 75 with a width L1. The tops 75 of the application elements 74 extend parallel to one another and are spaced apart from each other by a distance D1. The application elements 74 may also have the height H1 above the surface 16 of the core 13. The rib-shaped application elements 74 may have an annular or helical shape about the core 13 (about the longitudinal axis X). According to embodiments, the width L1 is comprised between 40 and 400 μm, and preferably comprised between 200 and 400 μm. The distance D1 between the tops of the ribs is comprised between 350 and 450 μm, and is preferably equal to 400 μm (to within + or − 10%).

Any other shape of the top of the application elements 14 may also be suitable as an elliptical shape, or a polygonal shape inscribed in a circle or in an ellipse.

FIG. 7 represents a water drop 9 deposited on the surface of the tops 15, 65, 75 of the application elements 14, 64, 74. FIG. 7 also shows an angle A1 between the surface 15, 65, 75 and a line tangent to the drop 9 at an intersection point between the drop and the surface 15, 65, 75. It is understood here that the smaller the angle A1, the greater the penetration of the drop 9 into the relief and therefore the more the relief has a hydrophilic character. Inversely, at the angles greater than 90°, the surface is generally considered to have a hydrophobic character.

Table 1 groups examples of top dimensions and distances between the tops and the angles A1 measured in the perpendicular directions X1 and X2, indicated in FIGS. 5 and 6, the direction X1 being parallel to the length of the rectangles 65 or the ribs 75.

TABLE 1

| | Dim. | D1 | A1 // X1 | A1 // X2 |
|---|---|---|---|---|
| Shape of the tops | (μm) | (μm) | (°) | (°) |
| Circles (L1) | 90 | 90 | 129 | 129 |
| Circles (L1) | 150 | 150 | 126 | 126 |
| Rectangles (L1 × L2) | 400 × 200 | 400 | 114 | 129 |
| Ribs (L1) | 40 | 80 | 112 | 127 |
| Ribs (L1) | 90 | 200 | 92 | 125 |
| Ribs (L1) | 400 | 400 | 93 | 139 |

In the case of the rectangular-shaped tops 65 (FIG. 5), the distance D2 is selected to be equal to the distance D1.

Table 1 shows that the ribs (FIG. 6) and the rectangular shapes (FIG. 5) have a stronger hydrophobic character (angle A1 greater than 90°) in the direction X1 than in the direction X2. It also proves that the hydrophobic surfaces are often lipophilic and reciprocally, the hydrophilic surfaces are often lipophobic. In the scope of the applicators for cosmetic products which are generally greasy substances, this aspect may advantageously be exploited to obtain both a good retention of the cosmetic product on the applicator and a good availability of the product to be able to be easily transferred and spread from the applicator to the skin or to the eyelashes or the eyebrows.

FIGS. 8 and 9 represent applicators 2, 3, produced in one piece by a single molding operation, according to other embodiments. In FIG. 8, the applicator 2 comprises a rod 21 having a longitudinal axis X. The rod 21 is secured to an application member 22 comprising a core 23 carrying a plurality of application elements 24 distributed over at least one portion of the surface of the core 23. The core 23 has an elongated shape according to its longitudinal axis X, and a substantially conical distal end. The core 23 further comprises a groove 26 extending about the axis X. The groove 26 acts as a reservoir to retain more cosmetic product. The groove 26 may have a circular (FIG. 8) or helical shape.

In FIG. 9, the applicator 3 comprises a rod 31 having a longitudinal axis X. The rod 31 is secured to an application member 32 comprising a core 33 carrying a plurality of application elements 34 distributed over at least one portion of the surface of the core 33. The core 33 has a shape combining two water drop-shaped portions 37, 38, whose longitudinal axes of revolution coincide with the axis X. The water drop shapes 37, 38 delimiting between them an annular groove 36 which can also act as a reservoir of cosmetic product. The water drop shape 38 on the distal side of the core 33 can be smaller than the water drop shape 37 on the proximal side of the core.

It will be clear to those skilled in the art that the present disclosure is open to diverse variants and diverse applications. In particular, the disclosure is not limited to the previously described applicator shapes. Other applicator shapes may be suitable when the applicator has a relief with application elements having enlarged, substantially flat tops, likely to retain a cosmetic product and to transfer it to the skin or to the bristles (eyelashes, eyebrows).

Nor is the disclosure limited to an application member formed in one piece. Indeed, it may be envisaged to manufacture the application member by assembling several parts, for example by interlocking. These parts may include at least one surface on which application elements are formed. As previously, the application elements can have a top with a width greater than 35 μm and smaller than 450 μm. Each of these parts can be formed using a mold with a complementary shape and having a surface including cavities which can be produced using a femtosecond laser, to form the application elements. The different parts forming the core of the application member may or may not be identical.

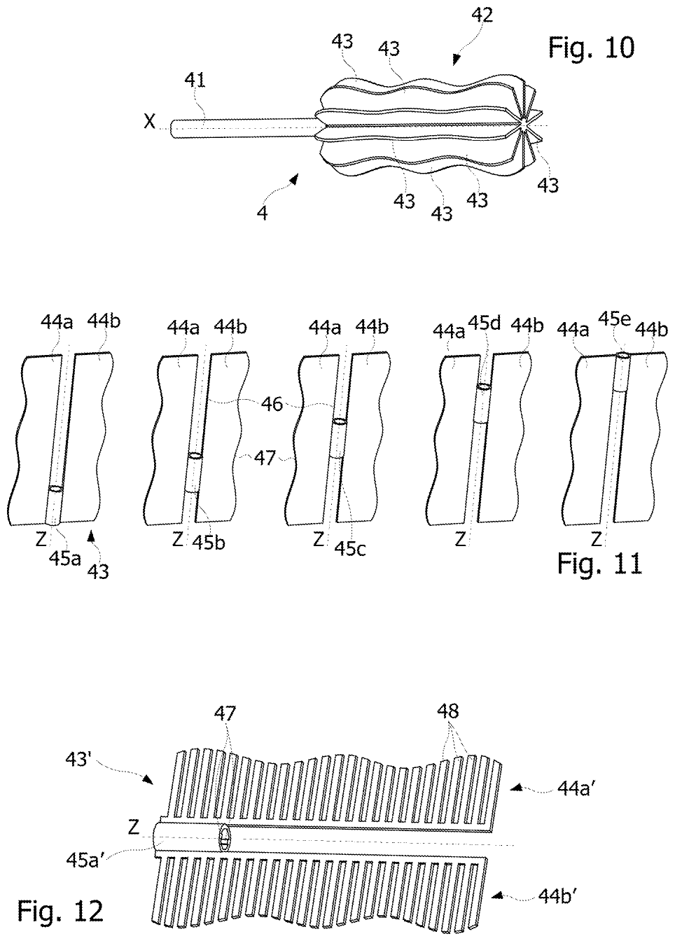

According to an embodiment illustrated by FIGS. 10 and 11, the assembled parts forming the core of the applicator 4 comprise parts 43 formed of two substantially rectangular-shaped portions 44a, 44b connected to each other by a portion 45a-45e forming a hub whose axis Z is parallel to an inner edge 46 of each rectangular portion. The parts are assembled to form the applicator using the rod 41 of the applicator, engaged in the hub 45a-45e of each of the parts 43, so as to form rectangular-shaped fins 44a, 44b distributed about the rod 41, in a same position along the longitudinal axis X of the rod 41 which coincides with the axis Z of the hubs 45a-45e. To this end, the respective hub 45a-45e of each of the parts 43 is arranged relative to the fins 44a, 44b at distinct locations along the axis Z spaced apart from the length of the hubs. In the example of FIGS. 10 and 11, the applicator 4 comprises five parts 43 each including two fins 44a, 44b.

According to an embodiment illustrated by FIGS. 10 and 11, the outer edges 47 of the fins 44a, 44b may have corrugations, in particular in order to facilitate the application of the cosmetic product.

According to one embodiment, the application elements 14, 64, 74 are formed on all or part of the faces of the parts 43. To this end, the corresponding faces of the molds allowing manufacturing the parts 43 may be treated using a femtosecond laser to form the cavities 94 at the desired locations. If required, a mirror system may be used to direct the laser beam on some faces of the mold, for example on the faces forming the thickness of the fins 44a, 44b. It should be noted that all parts 43 can be manufactured in a single molding step using a same mold comprising one molding cavity per part.

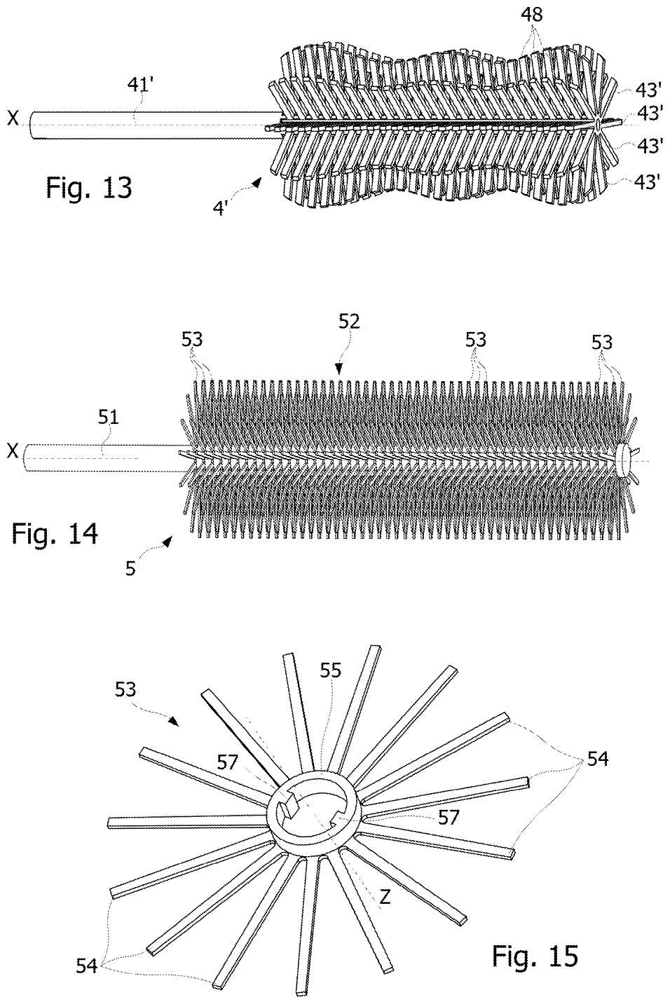

According to another embodiment illustrated by FIGS. 12 and 13, the fins 44a, 44b are cut in the form of combs. Thus in the example of FIGS. 12 and 13, the applicator 4′ comprises parts 43′ forming fins 44a′, 44b′ whose corrugated outer edges are cut so as to form teeth 48, the set of teeth 48 of each fin 44a′, 44b′ forming a comb. The applicator 4′ can thus be adapted so that the teeth 48 can pass between the eyelashes.

According to one embodiment, the hub 45a-e, 45a′ of the parts 43, 43′ comprises axial ribs 47 formed inside the hub. The ribs 47 are intended to cooperate with slots with a complementary shape formed on the rod 41, 41′ of the applicator. Thus, the parts 43, 43′ can be introduced on the rod 41, 41′ only in a determined angular position about the axis X of the rod. This arrangement allows for example uniformly distributing the fins 44a, 44b, 44a′, 44b′ about the rod 41, 41′.

According to one embodiment, the hub 45a-e, 45a′ of the parts 43, 43′ comprises axial slots 47 formed on the outer face of the hub. These slots are intended to receive the internal edges of the other parts 43, 43′ when the latter are engaged on the rod 41, 41′ to form the applicator 4, 4′.

According to another embodiment illustrated by FIGS. 14 and 15, the assembled parts forming the core of the applicator 5 comprise star-shaped parts 53, which are substantially flat and mounted coaxially on the rod 51 of the applicator. The parts 53 comprise a hub 55 and radial elements 54 extending radially about an axis Z of the hub 55. The hub 55 can be thicker than the radial elements 54 in the direction of the axis Z, to space the latter along the longitudinal axis X of the applicator 5. In the example of FIGS. 12 and 13, the applicator 5 comprises about 50 parts 53 and each of the parts 53 comprises 15 radial elements 54. The radial elements have a straight rectangular-shaped section.

According to one embodiment, the application elements are formed on all or part of the faces of the parts 53. To this end, the corresponding faces of the molds allowing manufacturing the parts 53 can be treated using a femtosecond laser to form the cavities 94 at the desired locations. If required, a mirror system can be used to direct the laser beam on some faces of the mold, for example on the faces forming the thickness of the radial elements 54. All parts 53 may have identical shapes, they can be manufactured using a same mold.

According to one embodiment, the hub 55 of the parts 53 comprises axial ribs 57 formed inside the hub. The ribs 57 are intended to cooperate with slots with a complementary shape formed on the rod 51 of the applicator 5. Thus, the parts 53 can be introduced on the rod 51 only in a determined angular position about the axis X of the rod. This arrangement allows for example aligning the free ends of the radial elements 54 along an axis parallel to the axis X of the rod 51, or arranging them differently, for example so as to distribute these ends along helices. It should be noted that the slots formed on the rod 51 are not necessarily aligned in the direction of the axis X, but can also follow a helical trajectory.

In addition, it may also be considered to mold the applicator or the different parts forming the applicator by injecting the thermoplastic material into the mold, mixed with an inert gas to obtain a foamy appearance.

1. An applicator for a cosmetic product on the skin or bristles, comprising an application member made of a thermoplastic elastomer material, the application member comprising:
a core extending along a longitudinal axis, and
application elements formed at the surface of the application member, each of the application elements having a top with a width greater than 35 μm and smaller than 450 μm.

2. The applicator according to claim 1, wherein the top of the application elements has a length larger than their width.

3. The applicator according to claim 1, wherein the top of the application elements has a rectangular shape, or the application elements have the shape of parallel ribs.

4. The applicator according to claim 1, wherein the application elements have a width comprised between 40 and 400 μm.

5. The applicator according to claim 1, wherein the application elements have a height comprised between 350 and 600 μm.

6. The applicator according to claim 1, wherein the application elements, are spaced apart from each other by a distance comprised between one and two and a half times the width of the top of the application elements.

7. The applicator according to claim 6, wherein the core has a circular or helical-shaped groove.

8. The applicator according to claim 1, wherein the core comprises two drop-shaped portions arranged along the longitudinal axis, the two portions delimiting between them an annular groove.

9. The applicator according to claim 1, wherein the application member comprises a plurality of parts engaged on a rod of the applicator, the application elements being formed at the surface of the parts.

10. The applicator according to claim 9, wherein each of the parts (43, 43′) comprises two fin-shaped portions connected to each other by a portion (45a-45e) forming a hub in which the rod (41, 41′) of the applicator is engaged, the fin-shaped portions forming fins about the rod of the applicator.

11. The applicator according to claim 9, wherein each of the parts has the shape of a star with a hub in which the rod of the applicator is engaged and radial elements extending radially about the hub.

12. A method for manufacturing a cosmetic applicator according to claim 1, the method comprising a step of molding a thermoplastic elastomer material, using a mold complementary in shape to that of the applicator or a part of the applicator (4, 5), the mold having a plurality of cavities complementary in shape to those of the application elements of the applicator.

13. The manufacturing method according to claim 12, comprising a step of manufacturing a mold, the cavities being formed using a femtosecond laser.

14. A mold for manufacturing a cosmetic product applicator, according to claim 1, the mold comprising a molding surface having a plurality of cavities complementary in shape to those of the application elements of the applicator.
